(19) United States
(12) Patent Application Publication
(10) Pub. No.: US 2022/0036314 A1
(43) Pub. Date: Feb. 3, 2022

(54) SYSTEM AND METHOD FOR PROVIDING EMPLOYEE DRIVEN MOBILITY

(71) Applicant: JPMorgan Chase Bank, N.A., New York, NY (US)

(72) Inventors: Shawn Wesley ALEXANDER, Pearland, TX (US); Lauren KUCIC, Frisco, TX (US); Rhiannon SWEENEY, London (GB); Shruti KORADA, Wilmington, DE (US); Olivia BATCHELOR, London (GB); Autumn BREESE, Houston, TX (US)

(21) Appl. No.: 16/945,047

(22) Filed: Jul. 31, 2020

(51) Int. Cl. G06Q 10/10; G06F 16/903; G06F 16/9035; G06N 20/00

(52) U.S. Cl. CPC G06Q 10/1053; G06N 20/00; G06F 16/9035; G06F 16/90335

(57) ABSTRACT

An embodiment of the present invention is directed to a system and series of mobility processes where employees or candidates may identify their desire for mobility. For example, candidates (e.g., employees) may create a profile and signal their interest in being approached for roles and opportunities. For example, candidates may specify their recruitment status—such as “open to new roles,” “looking for a role,” “happy where I am”—that indicates their readiness for mobility and desire to explore opportunities with hiring managers. Their profile may include information relating to certifications, skills, experience as well as desired role, line of business, culture, and other dimensions that would help prospective hiring managers ascertain if the candidate is a good fit for their teams.

### FIELD OF THE INVENTION

The invention relates generally to a system and method for implementing an employee or candidate driven mobility infrastructure and environment.

### BACKGROUND OF THE INVENTION

Traditionally, job mobility is focused on a pull based design where employees must search for open requisitions or “reqs” and then apply for the openings. Current hiring models are based on first establishing a requisition before connecting the requisition to people who might be interested in the opportunity. Under this traditional model, the hiring managers (and organizations) are waiting for employees to apply while candidates are regularly checking job boards for the right position to open. For the right candidate to be matched with the right team requires that the timing is just right. However, this is oftentimes not the case which leads to missed opportunities.

These and other drawbacks exist.

### SUMMARY OF THE INVENTION

According to one embodiment, the invention relates to a system that provides employee driven mobility. The system comprises: an interactive interface that communicates with a user via a communication network; a database that stores employee data, team data and associated analytics and further accesses data from a plurality of sources; and a computer processor executing a mobility application, the computer processor coupled to the interactive interface and the database and further configured to perform the steps of: enabling, via the interactive interface, the user associated with a team to access the mobility application; initiating a search to identify a match comprising one or more candidates for a position with the team; wherein the one or more candidates comprise at least one candidate with a mobility profile comprising a mobility interest status; identifying one or more commonalities with the team and the at least one candidate; initiating a contact with the at least one candidate form the one or more candidates to engage in a mobility communication; sharing a team interface with the at least one candidate; and enabling the at least one candidate and the user to engage in the mobility communication.

According to one embodiment, the invention relates to a method that provides employee driven mobility. The method comprises the steps of: enabling, via an interactive interface, the user associated with a team to access the mobility application, wherein the interactive interface that communicates with a user via a communication network; initiating, via a computer processor executing a mobility application, a search to identify a match comprising one or more candidates for a position with the team; wherein the one or more candidates comprise at least one candidate with a mobility profile comprising a mobility interest status; identifying one or more commonalities with the team and the at least one candidate; initiating a contact with the at least one candidate form the one or more candidates to engage in a mobility communication; sharing a team interface with the at least one candidate; and enabling the at least one candidate and the user to engage in the mobility communication.

The system may include a specially programmed computer system comprising one or more computer processors, interactive interfaces, electronic storage devices, and networks. The computer implemented system, method and medium described herein provide unique advantages to organizations, hiring managers, employees, candidates and other users, according to various embodiments of the invention. An embodiment of the present invention is directed to shifting the burden of job matching from the employee to the hiring manager. With an embodiment of the present invention, the hiring manager can apply to the employee instead of the employee applying to a job opening. Under this scenario, the hiring manager is the one searching and contacting qualified candidates to strategically grow and build their team. In addition, the hiring manager is able to search an available pool of individuals who are interested (or will be interested in the future) and start building relationship foundations from which to build and grow the team. This improves the overall hiring process and quality of matched candidates, as the employee or candidate will have multiple opportunities to select from instead of having to apply to a limited set of requisitions.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary flowchart, according to an embodiment of the present invention.

FIG. 2 is an exemplary system diagram, according to an embodiment of the present invention.

FIG. 3 is an exemplary user interface, according to an embodiment of the present invention.

FIG. 4 is an exemplary user interface, according to an embodiment of the present invention.

FIG. 5 is an exemplary user interface, according to an embodiment of the present invention.

### DETAILED DESCRIPTION OF THE PREFERRED EMBODIMENT(S)

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

Currently, mobility is a static, point-in-time transaction where the hiring manager must be looking for a candidate and the candidate must be looking for a new opportunity. In this current scenario, the hiring manager and candidate could miss good mobility opportunities as the candidate may not be searching for roles in the exact time window. Here, timing needs to be just right for the right candidate to be interested at the same time an optimal team is looking to hire for that candidate.

An embodiment of the present invention may be used by external candidates and employees within an organization that are desiring to move to a different team, branch, affiliate, subsidiary or other environment within the organization. For example, an organization may have many teams, lines of business, affiliates, subsidiaries, etc. Some organizations even encourage team members to leave their current team or role to take on a limited or temporary project on another team to gain experience and exposure. In addition, the various embodiments of the present invention may be applied to external candidates looking for opportunities within an organization. Other scenarios and applications may be applied.

An embodiment of the present invention is directed to a system and series of mobility processes where candidates (e.g., external candidates, internal employees, etc.) can identify their desire for mobility. Candidates may create a profile and signal their interest in being approached for roles and opportunities. For example, candidates may specify their recruitment status—such as “open to new roles,” “looking for a role,” “happy where I am”—that indicates their readiness for mobility and desire to explore opportunities with hiring managers. Their profile may include information relating to certifications, skills, experience as well as desired role, line of business, culture, and other dimensions that would help prospective hiring managers ascertain if the candidate is a good fit for their teams.

Instead of a candidate being matched and interviewed for a specific role, the team can apply to hire the candidate and the candidate can select the best fit team for their development needs and career aspirations. With an embodiment of the present invention, hiring managers may search for candidates ready for a new role or open to having conversations about new opportunities and then connect with those candidate s accordingly. In addition to expressing a desire to be approached for new roles, candidates may search out teams that meet the culture, technology, and engagement maturity that they are looking for. Even if the team currently has no open roles, the candidate may express an interest in future opportunities that may open up on the team. Here, the candidate may access a list of team members they can network with in the meantime.

With an embodiment of the present invention, candidates may indicate their willingness to be approached for opportunities so that team matches can occur even if the candidate is not specifically searching for roles. In addition, candidates may express a future interest in a team they feel best suits them (e.g., “I got next” functionality). Candidates may effectively “raise a hand” expressing an interest in mobility. Here, hiring managers may search for those candidates that are a good fit for their upcoming roles.

According to an exemplary illustration, an embodiment of the present invention may provide employees, such as global technology employees, with a holistic view of mobility opportunities across various Lines of Business (LoBs). An embodiment of the present invention is directed to providing a clear visualization of what mobility may mean for an individual taking a role and for the team that they would be joining. An embodiment of the present invention provides technologists with a highly integrated mobility experience that is tailored to their job roles.

An embodiment of the present invention is directed to delivering core objectives of: transparency; empowering technology talent; and engaging employee experiences.

An embodiment of the present invention provides transparency to teams looking for new talent and for individuals looking for new opportunities. For example, with an embodiment of the present invention, employees have clarity about open roles and required skills as well as what it is like to work on the team and an understanding of the technical delivery.

An embodiment of the present invention enables employees to find teams with the right role, behavior, environment and technical capabilities thereby allowing teams to find talent that fits with the team from a cultural and skill background. An embodiment of the present invention may further partner with and/or leverage existing systems of records (SORs) (e.g., human capital management, application management tools, project management systems, etc.) to provide a complete and accurate picture of the team, organization, role, and technology landscape.

An embodiment of the present invention allows employees to discover new teams that may not yet have a demand but that they can follow and express an interest in joining in the future. This provides an engaging employee experience.

An embodiment of the present invention is directed to providing a system and method that makes it easy for teams to build a talent pipeline, managers to search for new talent, and employees to find new opportunities and new teams to work on. Teams may further create a narrative that describes their day-to-day experience and for employees to describe their preferred way to work.

An embodiment of the present invention aims to empower various users, such as employees who are interesting in mobility, teams who are seeking candidates and employees who have an interest in a move down the road. For example, employees may search for open roles with clarity on team behavior and structure, understanding of a broader LoB organization, and specific technology delivered for the role. In addition, employees and managers may connect by allowing teams to search for future members as well as individuals to search for future teams. Accordingly, an embodiment of the present invention may be applied to various use cases, including current mobility candidates, hiring managers and/or teams and future mobility candidates.

Current mobility candidates may include employees or external candidates looking for mobility opportunities. An embodiment of the present invention is directed to assisting candidates understand how teams in an organization and/or location work, what they work on, and what a role on that team might look like day-to-day. An embodiment of the present invention further allows candidates to access team and work details on an open demand. An embodiment of the present invention provides visibility into what the teams work on, what technologies they use, and where the team and technology is on its modernization journey. An embodiment of the present invention further allows candidates to compare teams with open roles and connect with current and previous team members to gain a comprehensive understanding of options.

Teams may include Hiring Managers; Supervisors, Team Members (Employees), etc. An embodiment of the present invention provides visibility into mobility candidates currently looking for roles as well as candidates who are open to mobility conversations. An embodiment of the present invention facilitates connections with interested and potentially interested candidates. For example, a user (whether candidate or hiring manager) may view the work current teams perform and understand how the candidate may fit within a particular team or environment. An embodiment of the present invention further allows users to advertise team behaviors, guiding principles, and technical accomplishments to attract and pique the interest of mobility candidates or even a particular, specific candidate or type of candidate. An embodiment of the present invention allows users to see a mobility pipeline of people that want to join the team, allowing users to accelerate or defer demand decisions based on availability and/or interest of talent.

Future mobility candidates may include employees or candidates wanting to find teams to follow for future mobility. An embodiment of the present invention allows candidates to search for and indicate an interest in future opportunities in teams they may want to join in the future. An embodiment of the present invention enables candidates to build a custom development plan based on a future team's skills, needs and a current and past history of work. An embodiment of the present invention notifies candidates when teams of interest have new openings or other opportunities. An embodiment of the present invention may display a network's “nearest point of contact” with the team so that a candidate can introduce himself or herself based on a prior connection or otherwise make a connection.

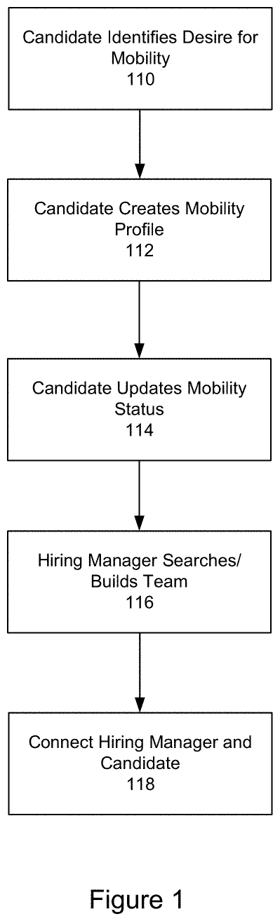

FIG. 1 is an exemplary flowchart, according to an embodiment of the present invention. At step 110, a candidate may identify a desire for mobility. At step 112, the candidate may create a mobility profile. At step 114, the candidate may update a mobility status. At step 116, a hiring manager may search and/or build a team. At step 118, the hiring manager and the candidate may connect. While the process of FIG. 1 illustrates certain steps performed in a particular order, it should be understood that the embodiments of the present invention may be practiced by adding one or more steps to the processes, omitting steps within the processes and/or altering the order in which one or more steps are performed. Additional details for each step are provided below.

At step 110, a candidate may identify a desire for mobility. The candidate may represent a current employee or an external candidate. The desire for mobility may represent an interest in mobility and may further include mobility specifics including a position, team, growth in a technology or leadership skill and/or other employment goal. The candidate may access a mobility application through a mobile device, desktop application and/or other user device.

At step 112, the candidate may create a mobility profile. The mobility profile may include details concerning experience, qualifications, training, awards, certificates, tenure, etc. This information may be automatically retrieved from a human resources system and/or other source, e.g., existing profile on an application, resume, etc. Other details may include personality information, sample work product, qualitative data, social data, etc. The profile may include a persona, avatar or other icon representing the candidate. For example, a candidate may not want to expose his or her name when searching for a new position within an organization. Other masking techniques may be applied. In addition, the candidate may include a do not match list to avoid getting matched with certain teams, managers and colleagues.

At step 114, the candidate may update a mobility status. The candidate's mobility status and desire may be updated as the candidate wishes. The candidate's status may be selected from a predetermined list. In addition, the candidate may provide a personalized status. For example, status may include: “I'm interested in mobility,” “I'm interested in having mobility conversations,” “I'm not interested.” Other options may include using an emoticon, emoji and/or other graphic or animation to express a candidate's status or sentiment.

According to another embodiment, the candidate may set up variations in status depending on the hiring managers or teams. For example, a candidate may be content at his or her current position but would consider a position at a supervisory role or other “dream job.” In other words, the candidate is only willing to move for a promotion and may limit interest to roles and/or teams that offer management positions. To other teams, the candidate may project no interest. In another example, a candidate may only be interested in teams that offer remote work options and project a mobility interest to such teams and no interest to all others.

With an embodiment of the present invention, a candidate may access an inbox of individuals, hiring managers or teams who have searched for the candidate based on their availability. A candidate may then view a team page from a hiring manager. The team page may include team details, team/work description, culture insights, future plans/goals, contact information, communication portal, and an option to express an interest. For example, the team page may indicate to a candidate that the team is looking to modernize and upgrade their application using a particular tool or innovation. The team page provides a sense of culture, team philosophy, and ability to engage with the team as a whole and/or at an individual level.

An embodiment of the present invention may also provide network connection mappings and details. This may include commonalities with team members. Commonalities may represent connections based on common personal contacts, technology experience, work experience, etc. Personal contacts may include contact/personal information regarding how you know individuals on the team, whether you worked with them before, have you been in meetings, trainings, conferences and other events with them before, etc. Technical connections may include common technical experience, certificates, training programs, education, etc. Other commonalities may include working in the same location, same building, department, floor, etc. An embodiment of the present invention may provide a network connection mappings for a candidate and a team. The network connection mappings may illustrate how close a candidate is to a team and further identify common contacts, events, etc. For example, upon identify a mutual relationship, one party may seek an introduction through the mutual relationship to better facilitate the initial meeting.

At step 116, a hiring manager may search and/or build a team. The hiring manager may enter search terms or identify qualifications to identify a potential candidate. For example, the hiring manager may search for a specific skill set and/or qualification. This may also include locations, similar experience/technology and/or other factors. According to another example, the system may have access to personality information or sentiment data to determine how the candidate would fit in with a team or type of team. In another example, an embodiment of the present invention may generate a personality assessment based on the candidate's evaluations, likes, dislikes, tendencies, affiliations, and other markers. Even if the candidate is not actively seeking mobility, the hiring manager may express an interest in the potential candidate. This enables the hiring manager to actively recruit the candidate and further market the interested team.

An embodiment of the present invention enables a hiring manager to search for a specific candidate. For example, a team may need a team member to help with integrating machine learning in a specific application environment. Rather than someone with general machine learning experience, a hiring manager may seek someone who has experience in performing machine learning integration. If someone with this specific experience does not exist, an embodiment of the present invention may find someone who is close to the optimal skill set (close in technology and experience).

If a candidate is interested in a team, the candidate may follow the team via a team page. In addition, an interested team may follow a candidate profile and look for opportunities to connect. The team may push notifications of events and any team changes in an effort to attract the candidate. For example, when the candidate updates the profile to express an openness to mobility conversations, the team may initiate a conversation and provide a tailored team page that provides a mobility plan and transition. In addition, by following the candidate, the team may be better positioned to offer an incentive, benefit or bonus that is of particular interest to the candidate. For example, a candidate may express an interest in traveling. In this example, the team may highlight travel opportunities in the new role for the first six months. According to another example, the candidate may describe a “dream job” where the system may then identify potential matches based on factors associated with the dream job description. If a team is following and interested in this candidate, the hiring manager may adjust a current opening or create a new opening to cater to the desired candidate.

At step 118, the hiring manager and the candidate may connect. When a match or multiple matches are made, a hiring manager may seek to connect with one or more matching candidates. The hiring manager may send a team page that may be customized to the candidate. If team culture is an important factor for the candidate, the team page may include information about team building events, social events and testimonials from current team members about the team's work environment. Also, if remote work options and autonomy are important, the team page may highlight remote work budget for equipment and other technology benefits. In addition, the hiring manager and candidate may schedule a virtual or in-person meeting. For example, the hiring manager may have an upcoming trip to the office location of the candidate and schedule a coffee meeting as an introductory connection. The hiring manager may invite the candidate to attend an event, such as a social event, team building event, etc. This provides the candidate a better understanding of what it is like to be on the team. The candidate may gain insights into the culture, how the team members communicate, etc.

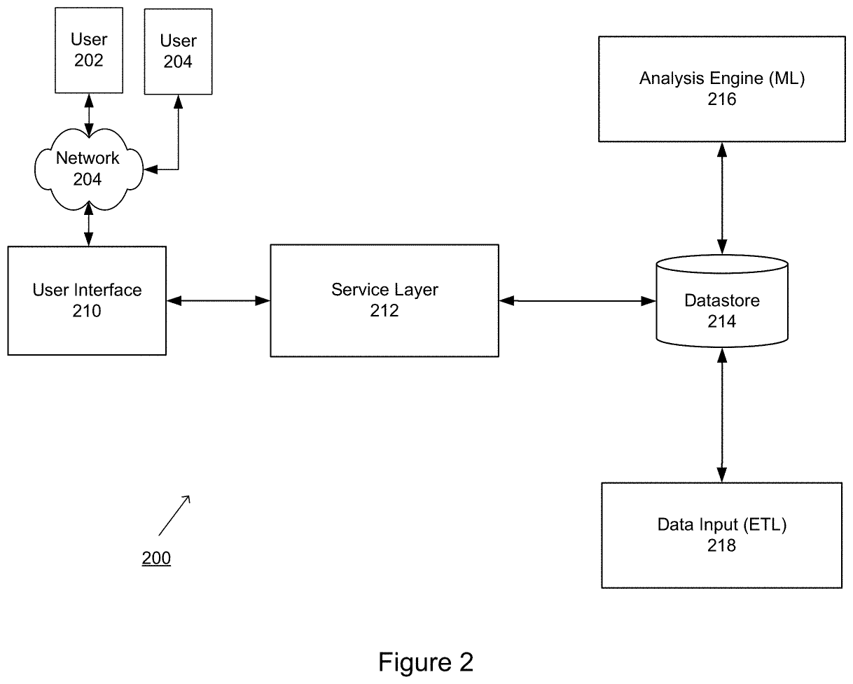

FIG. 2 is an exemplary system diagram, according to an embodiment of the present invention. As shown in FIG. 2, User Interface 210 may communicate with Service Layer 212. Service Layer 212 may access data from Database 214. Database 214 may communicate with Analysis Engine 216 and receive data from Data Input 218. Data Input 218 may access data from various sources including internal and external applications and systems.

Service Layer 212 may support various functions and features associated with employee driven mobility. Server Layer 212 may query Datastore 214 which may represent a no-SQL data store. Datastore 214 may store and manage employee data, team data as well as analytics, graphs and other associated data.

Analysis Engine 216 may generate and apply data models to identify correlations between candidates and teams. An embodiment of the present invention may apply machine learning and data analytics to a candidate profile to determine experience, what the candidate has worked on, who the candidate worked with, etc. In this example, Analysis Engine 216 may aggregate and analyze various events associated with a candidate and generate a graph of a candidate's activity, actions, events, work history, social contacts, etc. An embodiment of the present invention may determine how a candidate's graph fits in a team's hiring needs. The candidate graph may consider quantitative as well as qualitative data. The candidate graph may be queried to understand connections and other analytics.

An embodiment of the present invention may be based on a framework that aims to create visibility to mobility opportunities leveraging key dimensions of “technical” and “people/team.” Each of these dimensions may be broken into subcategories with aligned metrics falling beneath each. Each team's metrics may then be plotted on an index to provide the team a view of how they are performing against each competency, including point in time and over a series of months, years and/or other time period. For example, “technical” metrics may include: speed, scalability, stability and security. Technical metrics may be technology or project specific. For example, technical metrics may include application quality, performance, engineering efficiency, operational hygiene (e.g., incident data, resiliency data, etc.). Other metrics may be program based and include readiness data, operational risk, etc. This data may represent how a candidate performs on the job and may also indicate a level of proficiency and competency in certain technical skills and other skillsets.

People/team metrics may represent how well a candidate works in a team and other social skills. People/team metrics may include: connect with purpose; team enablement, team or build trust and grow talent. Individual data metrics that are aggregated together may be aligned to the key dimensions to highlight the team health and areas for improvement. For example, connect with purpose metric may be based on data from human resources system that sources data from a human capital management system and sentiment data. For example, connect with purpose data points show how aligned the team is with an overall organization strategy and view. Team Enablement may include performance data and team data; sentiment data, team recognition (e.g., awards, patents, etc.); training data (e.g., certificates, degrees, courses, conferences, etc.). Team enablement represents how empowered and supported the team is and whether or not the team has the resources they need to complete their jobs. Building trust metric may be based on sentiment data, log-in hours, diversity, coaching and development. For example, building trust relates to the team culture and whether or not they trust each other and the broader organization they are in and management they report to. Growing talent may be based on sentiment data, career management, etc. Growing talent is about whether or not the team has sufficient resources, challenges, and work to grow their skills and their careers (both individually and collectively) over time. Additional key dimensions may be added as organization or entity progresses including reviewing performance indicators for managers and team members. For example, how well the team looks in relation to their peers and broader organization may determine the recommendations and actions the team may take to improve these categories.

These metrics may be confirmed and applied to a calculation model in partnership with metric owners. An exemplary working model may define levels of maturity for each metric and subsequently assign points based on level. An embodiment of the present invention may provide a visualization via a dashboard, portal and/or other user interface.

Data Input 218 may receive data from various disparate data feeds. Data feeds may include sources that provide application quality data, infrastructure quality data, engagement data, communicate data, communication servers, etc. Data may be batch processed and loaded on a continuous basis and refreshed often.

An embodiment of the present invention may also apply predictive analytics to determine confidence levels regarding how well a candidate may fit within a team. Other observations and analytics may be applied.

An organization may host the system illustrated in FIG. 2. Users may interact with User Interface 210 via network communications, which may include internal networks as well as external networks. For example, users may access through a mobile device, mobile application as well as an application via a corporate network or other intranet. User Interface 210 may represent an interactive user interface that receives user's inputs and requests. Users 202, 204 may include individual employees, teams, hiring managers, Lines of Businesses and/or other users. Users 202, 204 may also represent external candidates seeking employment or opportunities from the organization.

The system 200 of FIG. 2 may be implemented in a variety of ways. Architecture within system 200 may be implemented as hardware components (e.g., module) within one or more network elements. It should also be appreciated that architecture within system 200 may be implemented in computer executable software (e.g., on a tangible, non-transitory computer-readable medium) located within one or more network elements. Module functionality of architecture within system 200 may be located on a single device or distributed across a plurality of devices including one or more centralized servers and one or more mobile units or end user devices. The architecture depicted in system 200 is meant to be exemplary and non-limiting. For example, while connections and relationships between the elements of system 200 are depicted, it should be appreciated that other connections and relationships are possible. The system 200 described below may be used to implement the various methods herein, by way of example. Various elements of the system 200 may be referenced in explaining the exemplary methods described herein.

Network 204 may be a wireless network, a wired network or any combination of wireless network and wired network. For example, Network 204 may include one or more of an Internet network, a satellite network, a wide area network (“WAN”), a local area network (“LAN”), an ad hoc network, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11g, 802.11n, 802.11ac, or any other wired or wireless network for transmitting or receiving a data signal. Also, Network 102 may support an Internet network, a wireless communication network, a cellular network, Bluetooth, or the like, or any combination thereof. Network 204 may further include one, or any number of the exemplary types of networks mentioned above operating as a stand-alone network or in cooperation with each other. Network 204 may utilize one or more protocols of one or more network elements to which it is communicatively coupled. Network 204 may translate to or from other protocols to one or more protocols of network devices. Although Network 204 is depicted as one network for simplicity, it should be appreciated that according to one or more embodiments, Network 204 may comprise a plurality of interconnected networks, such as, for example, a service provider network, the Internet, a cellular network, corporate networks, or even home networks, or any of the types of networks mentioned above.

Data may be transmitted and received via Network 204 utilizing a standard networking protocol or a standard telecommunications protocol. For example, data may be transmitted using Session Initiation Protocol (“SIP”), Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet Protocols (“TCP/IP”), hypertext transfer protocol (“HTTP”), hypertext transfer protocol secure (“HTTPS”), real time streaming protocol (“RTSP”), or other protocols and systems suitable for transmitting and receiving data. Data may be transmitted and received wirelessly or in some cases may utilize cabled network or telecom connections such as an Ethernet RJ45/Category 5 Ethernet connection, a fiber connection, a cable connection or other wired network connection.

While FIG. 2 illustrates individual devices or components, it should be appreciated that there may be several of such devices to carry out the various exemplary embodiments. Users may communicate with various entities using any mobile or computing device, such as a laptop computer, a personal digital assistant, a smartphone, a smartwatch, smart glasses, other wearables or other computing devices capable of sending or receiving network signals. Portal 130 may represent a user interface and/or other interactive communication portal.

Service Layer 212 may be communicatively coupled to Database 214. Database 214 may represent multiple database and storage components that include any suitable data structure to maintain the information and allow access and retrieval of the information. For example, Database 214 may keep the data in an organized fashion and may be an Oracle database, a Microsoft SQL Server database, a DB2 database, a MySQL database, a Sybase database, an object oriented database, a hierarchical database, a flat database, and/or another type of database as may be known in the art to store and organize data as described herein.

Database 214 may be any suitable storage device or devices. The storage may be local, remote, or a combination thereof with respect to Database 214. Database 214 may utilize a redundant array of disks (RAID), striped disks, hot spare disks, tape, disk, or other computer accessible storage. In one or more embodiments, the storage may be a storage area network (SAN), an internet small computer systems interface (iSCSI) SAN, a Fiber Channel SAN, a common Internet File System (CIFS), network attached storage (NAS), or a network file system (NFS). Database 214 may have back-up capability built-in. Communications with Database 214 may be over a network, or communications may involve a direct connection with Database 214. Database 214 may also represent cloud or other network based storage.

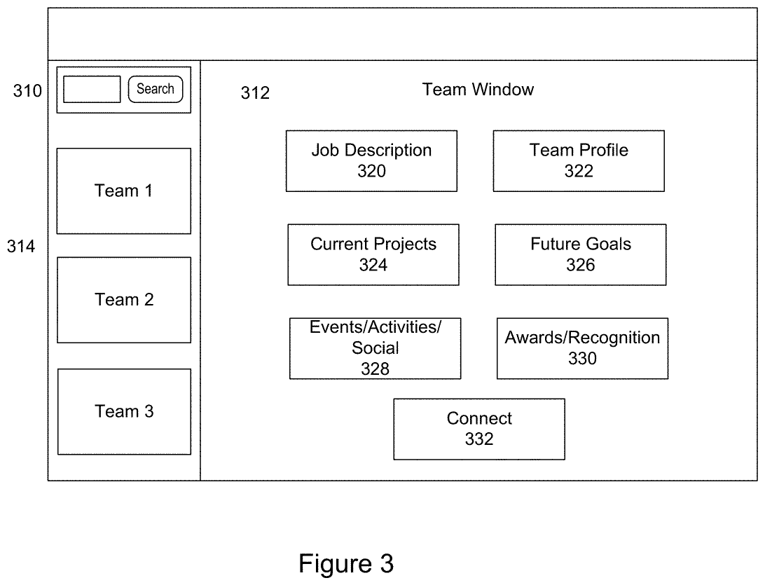

FIG. 3 is an exemplary user interface, according to an embodiment of the present invention. A candidate or employee may access a User Interface and search for a team or other opportunity at search/filter icon 310. Main panel 312 may represent Team data. For example, on login, 312 may default to a current team. When selecting a team card at 314, team data may shift to that team, e.g., Team 1, Team 2, Team 3. Details may include Job Description 320, Team Profile 322, Current Projects 324, Future Goals 326, Events/Activities/Social 326, Awards/Recognition 330 and Connect 332. In addition, panel 314 may provide the ability to scroll for teams. Other modules and/or interfaces may be implemented in accordance with the various embodiments of the present invention.

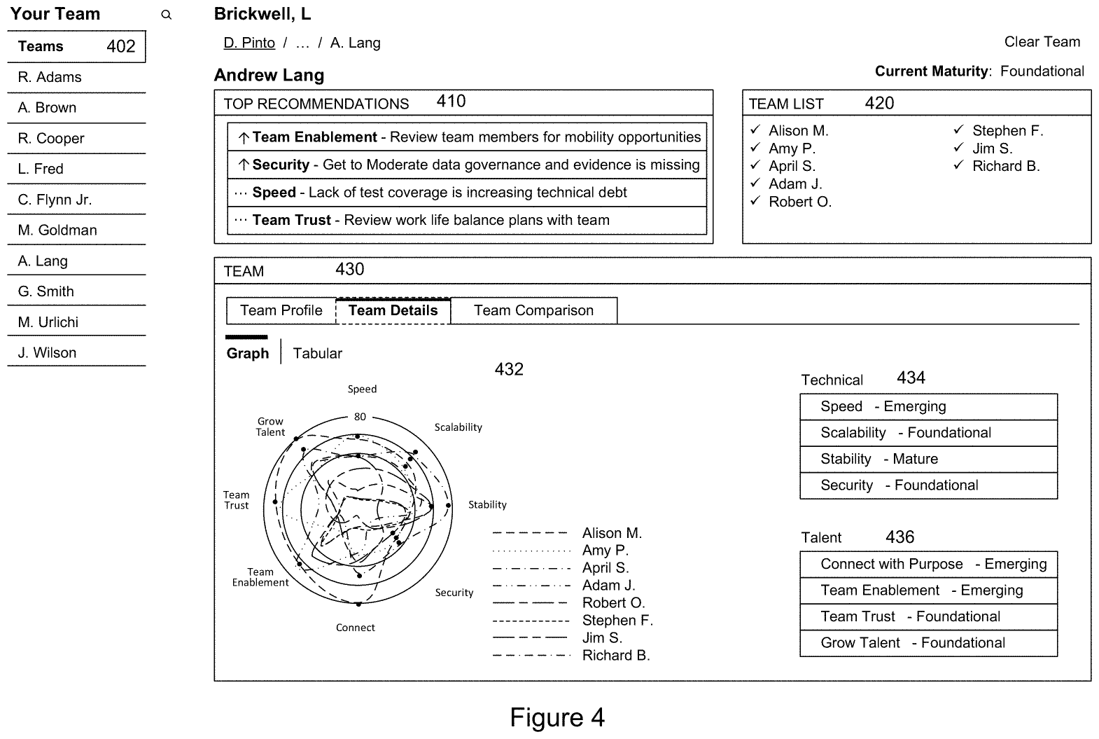

FIG. 4 is an exemplary user interface, according to an embodiment of the present invention. FIG. 4 is an exemplary illustration of a Team Interface. For example, FIG. 4 may represent a view for the team to see how they match with other comparable teams in their location, LOB, across the company or other factor. Top Recommendations at 410 may be based on key dimensions and represent metrics, goals and tasks for the team to improve and focus on.

According to an embodiment of the present invention, FIG. 4 may also represent a view for mobility candidates to see what a team looks like and then compare to a current team or other team of interest. In this exemplary scenario, the mobility candidate may view areas for the team to improve, and the recommendations that have been provided to the team. The transparency across the site and team allows mobility candidates to compare available teams side by side to select the team with the best or optimal culture and shape (across multiple technical and workforce dimensions).

Mobility candidates may also find a team on their site to “follow,” effectively creating a pipeline of interested mobility candidates for the team to review. This creates competition between teams to be selected not just by current mobility candidates but by top talent on the site that may be looking in the future. Teams may want to improve now to cultivate mobility candidates for current needs but also to look better for future candidates and team needs.

For example, a Hiring Manager may view Top Recommendations at 410, Team List at 420 and corresponding team data at 430. Top Recommendations 410 may be calculated actions the team and management could take to make the largest or most significant improvement in areas where the team is significantly behind or different from other teams on the site or organization. For example, recommendations may look at actions other teams have taken (based on a machine learning algorithm to learn how other teams have historically responded to similar issues and succeeded in improving their score relative to their peers) and firmwide actions that are recommended for some or all teams that the team has not yet implemented.

In addition, recommendations may be prioritized based on actions that have historically provided the largest improvement (or other measure) by other similar teams and areas where the team may be considered significantly behind peer teams on their location and in their organization. For example, recommended actions may be weighted more heavily for historical actions that have successfully improved other teams rather than firmwide actions that are generally recommended.

Team List 420 may represent current team members. Team 430 may provide details such as Team Profile, Team Details and Team Comparison. Team Details may include a graphical display of each current team member and how they scale on various metrics. In this example, the metrics include technology metrics such as speed, scalability, stability and security. Other metrics may include people/team metrics such as connect, team enablement, team trust and grow talent. Other metrics and combination of metrics may be applied based on the type of application, line of business, industry, need and/or other considerations. The metrics may be tailored to environments and technology space. Team summary information concerning the metrics may be provided at Technical 434 and Talent 436. This provides a hiring manager a view for each team member as well as the team as whole.

For example, a hiring manager may use an embodiment of the present invention to better grow and build a team for a specific need, technology goal, project, and/or other business objective. Potential candidates may be provided at 402 where the Hiring Manager may view candidate details and see how the candidate would fit in with the current Team.

As shown in FIG. 4, the team may access a tab or other interactive icon (e.g., Team Pipeline or Team Matches) that displays candidates that match the team and/or have followed the team for current or future mobility opportunities. The team may review the candidates and the current team details for that candidate so they can determine if the candidate would be a good fit for the team.

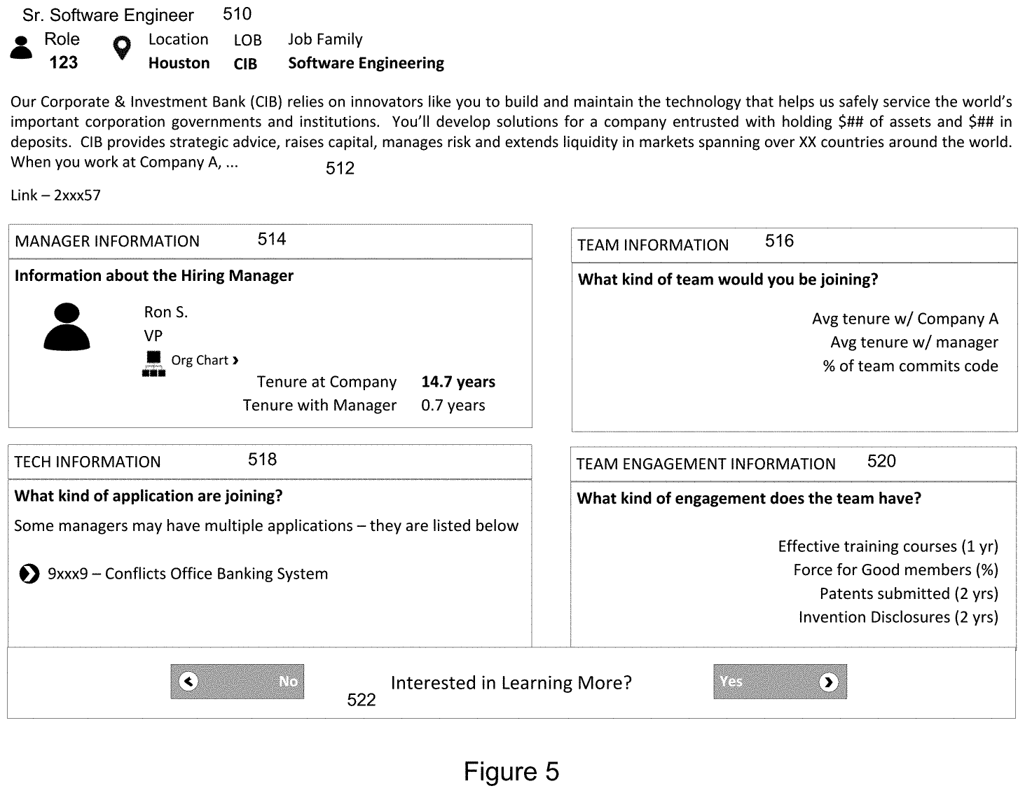

FIG. 5 is an exemplary user interface, according to an embodiment of the present invention. FIG. 5 represents a Team Page, according to an embodiment of the present invention. In the example of FIG. 5, a team has an opportunity for a Senior Software Engineer, as detailed at 510, which includes Role Title, Role Identifier, Location, Line of Business, Job Family, etc. A summary of the job description at 512.

FIG. 5 may also include Manager Information 514, Team Information 516, Technology Information 518 and Team Engagement Information at 520. The user may also respond by providing an indication of interest at 522. The exemplary interface of FIG. 5 may further link to other sources of information, documents, internal and external sites and links.

An embodiment of the present invention may also cater a Team Page to a particular user or type of user. This may refer to format as well as information. For example, some candidates may prefer text only while others respond better to graphics and data. Certain candidates may prefer high level summaries while others require detailed information.

An embodiment of the present invention may enable an employee to develop a career plan or path. For example, an entry level person may start at a company and develop a career goal which may include a “reach” or “dream” job or team. An embodiment of the present invention may provide a recommended path that includes acquiring specific skill sets, training, certificates and other specific experiences to better position the candidate for the objective down the road (which could be years). This may include a list of skill, training courses, technical experience that would position them well for that type of position in the future. The recommended path may have milestones, e.g., goals every 2 years and make sure the candidate is on track. An embodiment of the present invention may also provide reminders and even automatically enroll the candidate in training courses, etc. This provides benefits to the company by being able to groom and train up loyal employees and managers.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, the various embodiments of the present invention support a number of communication devices and components, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, JavaScript and/or Python. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

What is claimed is:

1. A system that provides employee driven mobility, the system comprising:
an interactive interface that communicates with a user via a communication network;
a database that stores employee data, team data and associated analytics and further accesses data from a plurality of sources; and
a computer processor executing a mobility application, the computer processor coupled to the interactive interface and the database and further configured to perform the steps of:
enabling, via the interactive interface, the user associated with a team to access the mobility application;
initiating a search to identify a match comprising one or more candidates for a position with the team; wherein the one or more candidates comprise at least one candidate with a mobility profile comprising a mobility interest status;
identifying one or more commonalities with the team and the at least one candidate;
initiating a contact with the at least one candidate form the one or more candidates to engage in a mobility communication;
sharing a team interface with the at least one candidate; and
enabling the at least one candidate and the user to engage in the mobility communication.

2. The system of claim 1, wherein the user is a hiring manager for the team.

3. The system of claim 1, wherein the mobility application executes on a mobile phone or a desktop device.

4. The system of claim 1, wherein the mobile interest status comprises an interest status and a future mobility interest status.

5. The system of claim 1, wherein the contact comprises an electronic communication within the interactive interface.

6. The system of claim 1, wherein the team interface comprises a team profile that includes data relating to current projects, future objectives, team culture and contact information.

7. The system of claim 1, wherein the match is determined by applying machine learning analysis to the employee data and the team data.

8. The system of claim 1, wherein the plurality of sources comprise internal and external systems of records that manage employee information.

9. The system of claim 1, wherein the one or more commonalities comprise common contacts and associated degrees of separation.

10. The system of claim 1, wherein the one or more commonalities comprise common technical skills and events.

11. A method that provides employee driven mobility, the method comprising the steps of:
enabling, via an interactive interface, the user associated with a team to access the mobility application, wherein the interactive interface that communicates with a user via a communication network;
initiating, via a computer processor executing a mobility application, a search to identify a match comprising one or more candidates for a position with the team; wherein the one or more candidates comprise at least one candidate with a mobility profile comprising a mobility interest status;
identifying one or more commonalities with the team and the at least one candidate;
initiating a contact with the at least one candidate form the one or more candidates to engage in a mobility communication;
sharing a team interface with the at least one candidate; and
enabling the at least one candidate and the user to engage in the mobility communication.

12. The method of claim 11, wherein the user is a hiring manager for the team.

13. The method of claim 11, wherein the mobility application executes on a mobile phone or a desktop device.

14. The method of claim 11, wherein the mobile interest status comprises an interest status and a future mobility interest status.

15. The method of claim 11, wherein the contact comprises an electronic communication within the interactive interface.

16. The method of claim 11, wherein the team interface comprises a team profile that includes data relating to current projects, future objectives, team culture and contact information.

17. The method of claim 11, wherein the match is determined by applying machine learning analysis to employee data and team data stored and managed in a database.

18. The method of claim 11, wherein the computer processor accesses data from a plurality of sources comprise internal and external systems of records that manage employee information.

19. The method of claim 11, wherein the one or more commonalities comprise common contacts and associated degrees of separation.

20. The method of claim 11, wherein the one or more commonalities comprise common technical skills and events.
